(19) United States
(12) Patent Application Publication
(10) Pub. No.: US 2023/0265661 A1
(43) Pub. Date: Aug. 24, 2023

(54) Fire protected building structures and methods for fire protecting building structures

(71) Applicant: SIEMONSEN & SIMONSEN APS, Skanderborg (DK)

(72) Inventor: Mikael Simonsen, Skanderborg (DK)

(21) Appl. No.: 18/041,180

(22) PCT Filed: Jul. 6, 2021
(86) PCT No.: PCT/EP2021/068677

§ 371 Date: Feb. 9, 2023

(30) Foreign Application Priority Data
Aug. 18, 2020 (DK) PA 2020 00930

(51) Int. Cl. E04F 13/08; A62C 2/06

(52) U.S. Cl. CPC E04F 13/081; A62C 2/06; E04D 9/00

(57) ABSTRACT

A building structure includes a mineral fibrous sheet material having a Temperature Index measured according to ISO 4589-3:2017 of 400° C. or higher, wherein the sheet material has a thickness of at most 1 mm, and wherein mineral fibers forming the sheet material are coated with a coating adapted for retarding fire.

### FIELD OF THE INVENTION

The present invention relates to the field of building structures.

### BACKGROUND OF THE INVENTION

Traditionally, thatched roofs are fire protected covering the laths of the roof structure with a fire-resistant and very diffusion permeable glass matting. Fire tests have shown that this method is functioning very well, and that it reduces burn-through on the face sections of the thatched roof. When a fire occurs in a thatched roof, only smouldering fire will occur on the face sections as the fire does not ignite any straw material. The fire will seek to the edges of the thatched roof, where there is more oxygen available. The presence of a surplus of oxygen increases the temperature in this region to above the melting temperature of the glass matting that melts at 600- 800° C., resulting in the fire getting free access to the underlying roof structure.

In order to avoid melting of the edge area of the glass matting, a narrow mineral wool mat of maximum 15 cm, preferably about 5 cm is used to cover the side edges and eaves of the thatched roof, thereby protecting the glass matting from melting. However, the presence of a mineral wool mat reduces the ventilation of the thatched roof in this area, causing areas with risk of rotting of the straw material. Furthermore, in the process of positioning the mineral wool mat, a considerable amount of dust is generated, and manipulation of the mineral wool mat results in breakage of the fibres, which, in turn, results in the formation of tiny fragments that no longer have the properties of a fibre. These tiny fragments can form small dust particles that cause irritation of the skin, eyes, nose and throat of the installer. In some cases, inhalation of the dust particles can lead to serious medical consequences.

### OBJECT OF THE INVENTION

The objective of the present invention is to provide a solution that solves at least some of the above problems.

### DESCRIPTION OF THE INVENTION

Surprisingly, the inventors have found that mineral wool can be replaced by a very thin mineral fibrous sheet material for fire protecting building structures. This solution obliviates the problems with mineral wool and makes space for a much better ventilation of the building structures, such as the roof, floors, or facades. The mineral fibrous sheet material should be able to pass the flame retardancy test according to ISO 4589-3:2017, such that the mineral fibrous sheet material reaches an ignition temperature of 400° C. or higher in the test.

A first aspect relates to a building structure comprising a mineral fibrous sheet material (first type) having a Temperature Index measured according to ISO 4589-3:2017 of 400° C. or higher, wherein said sheet material has a thickness of at most 1 mm, and wherein mineral fibers forming said sheet material is coated with a coating adapted for retarding fire.

In the present context, the term “building structure” means a structural element forming part of a building, such as a roof, a floor, a façade, a wall or the like. Hence, it is not to be understood as a part of an electrical system.

In one or more embodiments, the mineral fibrous sheet material has a Temperature Index measured according to ISO 4589-3:2017 of at least 400° C., such as within the range of 400-2000° C., preferably at least 500° C., such as within the range of 500-1900° C., more preferably at least 600° C., such as within the range of 600-1800° C., such as at least 700° C., such as within the range of 700-1700° C., and even more preferably at least 800° C., such as within the range of 800-1600° C. A suitable example of such a sheet material is the XFR50 sheets produced by Scapa Group that is measured to have a Temperature Index measured according to ISO 4589-3:2017 above 1100° C., and probably above 1600° C.

As used herein, the term “mineral fiber” includes fibers manufactured from rock, slag, glass, or ceramic with or without binders. The mineral fibrous sheet material may be woven or non-woven (e.g., felt) and may e.g., be of glass fiber, silicate fiber, ceramic fiber and mixtures thereof.

In one or more embodiments, the sheet material has a mass per unit area of 100-1,500 gram per square meter measured according to ISO 2286-2:2016, such as 110-1,000 gram per square meter, preferably 120-500 gram per square meter measured according to ISO 2286-2:2016, and more preferably 130-400 gram per square meter measured according to ISO 2286-2:2016.

The mineral fibers are coated with a coating adapted for retarding fire. Examples of such a coating may e.g., be water glass, or a silicone, such as polydimethylsiloxane (PDMS) polymer, polydiphenylsiloxane (PDPS) polymer, or a polydimethyldiphenylsiloxane (PDMDPS) polymer. Preferably, the coating is a non-tacky silicone. Preferably, the coating comprises a nonorganic fire-resistant filler. Nonorganic fire-resistant fillers may be ceramic powder, metal, glass, metal oxides, or combinations of ceramic powder, metal, glass, or metal oxide fillers. Examples of fire-resistant fillers contemplated by the present invention are ferro oxide, titanium oxide, boron nitride, zirconium oxide, sodium silicate, and magnesium silicate, although others are suitable as well. Such coatings may e.g., be prepared as shown in US7652090, hereby incorporated by reference.

The sheet material has a thickness of at most 1 mm, preferably within the range of 0.1-1 mm, and more preferably within the range of 0.1-0.5 mm, e.g., 0.2-0.4 mm.

In one or more embodiments, the sheet material has a Limiting Oxygen Index measured according to ISO 4589-3:2017 of 30% or higher, such as at least 40%, preferably at least 50%, such as within the range of 60-100%, and more preferably at least 70%, such as at least 80%, and more preferably at least 90%. A suitable example of such a sheet material is the XFR50 sheets produced by Scapa Group that has a Limiting Oxygen Index measured according to ISO 4589-3:2017 of above 90%. Limiting oxygen index (LOI) is the minimum concentration of oxygen in a mixture of oxygen and nitrogen that is needed to support the flaming combustion of a material. It is expressed in volume percent (vol%). Standardized tests, such as the ISO 4589 and ASTM D2863, may be used to determine LOI values.

Preferably, the building structure is selected from the roof, floors, and facades.

In one or more embodiments, the building structure is a thatched roof structure, and wherein the mineral fibrous sheet material is forming part of the roof underlay. Preferably, the sheet material forms part of the underlay only at the side edges, eaves, and ridge of said thatched roof structure. The remaining part of the underlay may be a second type of mineral fibrous sheet material, e.g., having a melting point of 800° C. or higher, preferably a woven fiber glass sheet material with a chopped fiberglass sheet attached to its surface. Preferably, the second type of mineral fibrous sheet material is vapor permeable to allow for proper ventilation of the backside of the thatched roof. The term “vapor permeable” shall be described herein as meaning that gases and substances, which are carried or suspended in a gas (such as, but not limited to water vapor), can move across the sheet material.

Both the mineral fibrous sheet material (first type) and the second type of mineral fibrous sheet material may preferably be placed on the laths and/or rafters of the roof structure and below the roof. Alternatively, the mineral fibrous sheet material (first type) may be placed on top of the second type of mineral fibrous sheet material being placed on the laths of the roof structure and below the roof.

In one or more embodiments, the building structure is a façade with a cavity, preferably ventilated, between the building wall and the facade cladding, and wherein said sheet material is lining said building wall within said cavity.

When the façade comprises window and/or door openings, these openings are also lined with the mineral fibrous sheet material (first type). This way of fire protecting the window and/or door openings secures that if a window or door catches fire, the development of the fire will be substantially retarded.

In one or more embodiments, the façade is a part of a multifloored building, and wherein said cavity is blocked between two neighboring floors by an object covered by said sheet material (first type). Such an object may e.g., be of metal or wood, preferably metal.

In one or more embodiments, the façade is thatched. This type of façade has until now not been possible to make due to the risk of fire.

A second aspect relates to a method for establishing a fireproof building structure comprising covering or lining a building structure with a mineral fibrous sheet material (first type) having a Temperature Index measured according to ISO 4589-3:2017 of 400° C. or higher, wherein said sheet material has a thickness of at most 1 mm, and wherein mineral fibers forming said sheet material is coated with a coating adapted for retarding fire.

A third aspect relates to a method for establishing a roof construction for a thatched roof comprising:
placing an underlay directly upon the laths and/or rafters of the roof construction;
placing mineral fibrous sheet material having a width of 20-100 cm along the side edges and eaves of said roof construction;
thatching (i.e., laying straw material) said roof construction from the eaves and upwards;
placing mineral fibrous sheet material having a width of 20-100 cm along the ridge of said roof construction; and
thatching said ridge;
wherein said mineral fibrous sheet material (first type) has a Temperature Index measured according to ISO 4589-3:2017 of 400° C. or higher, wherein said sheet material has a thickness of at most 1 mm, and wherein mineral fibers forming said sheet material is coated with a coating adapted for retarding fire.

A fourth aspect relates to a method for establishing a roof construction for a thatched roof comprising:
placing an underlay directly upon the laths of the roof construction;
placing mineral fibrous sheet material having a width of 20-100 cm along the side edges, eaves and ridge of said roof construction; and
thatching (i.e., laying straw material) said roof construction from the eaves and upwards;
wherein said mineral fibrous sheet material (first type) has a Temperature Index measured according to ISO 4589-3:2017 of 400° C. or higher, wherein said sheet material has a thickness of at most 1 mm, and wherein mineral fibers forming said sheet material is coated with a coating adapted for retarding fire.

A fifth aspect relates to a method for establishing a façade for a building comprising:
lining the outer face of a building wall with a mineral fibrous sheet material;
fastening brackets to said outer face of said building wall; and
mounting a facade cladding to said brackets;

wherein said brackets are mounted such that a cavity is formed between said building wall and façade cladding;
wherein said mineral fibrous sheet material (first type) has a Temperature Index measured according to ISO 4589-3:2017 of 400° C. or higher, wherein said sheet material has a thickness of at most 1 mm, and wherein mineral fibers forming said sheet material is coated with a coating adapted for retarding fire.

As used in the specification and the appended claims, the singular forms “a”, “an”, and “the” include plural referents unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

It should be noted that embodiments and features described in the context of one of the aspects of the present invention also apply to the other aspects of the invention.

The invention is described in more detail in the following detailed description of a preferred embodiment, with reference to the figures.

### BRIEF DESCRIPTION OF THE FIGURES

FIG. 1 is a schematic drawing of a part of a thatched roof in accordance with various embodiments of the invention;

FIG. 2 is a cross-sectional view of a part of a façade in accordance with various embodiments of the invention; and

FIG. 3 is a cross-sectional view of a part of a façade of a multifloored building in accordance with various embodiments of the invention.

References

| | |
|---|---|
| 110 | Rafter |
| 120 | Roof batten |
| 132 | First type underlay |
| 134 | Second type underlay |
| 140 | Thatch |
| 150 | Sway |
| 210 | Building wall |
| 220 | Sheet material |
| 230 | Bracket |
| 240 | Façade cladding |
| 250 | Cavity |
| 260 | Object |
| 270 | Floor deck |

### DETAILED DESCRIPTION OF THE INVENTION

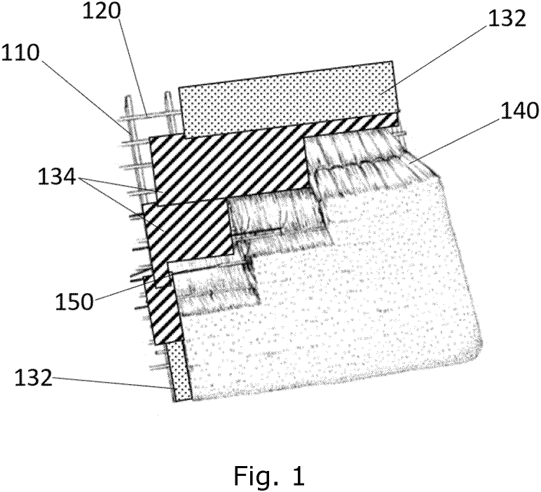

FIG. 1 shows a part of a thatched roof in accordance with various embodiments of the invention. The thatched roof is partly removed to show the different components. The thatched roof comprises rafters 110 and optionally roof battens 120, depending on the distance between the rafters 110. On top of the rafters 110 and/or roof battens 120 is positioned an underlay. According to the present invention, a specific first type 132 of underlay is used at the side edges, eaves, and ridge of the thatched roof structure. The underlay of a first type 132 is a mineral fibrous sheet material having a Temperature Index measured according to ISO 4589-3:2017 of 400° C. or higher, and has a thickness of at most 1 mm. The mineral fibers forming the sheet material of the underlay of a first type 132 is coated with a coating adapted for retarding fire. The underlay of a first type 132 may form part of the entire underlay, but it is preferred to use a second type 134 of underlay having a good vapor permeability to secure ventilation of the bundles of thatch 140. An example of a second type 134 of underlay may be a woven fiber glass sheet material with a chopped fiberglass sheet attached to its surface (i.e., a combi mat), preferably having a melting point of 800° C. or higher. The bundles of thatch 140 may be held in place by sways 150, which are split, or round rods made of e.g., steel, hazel, or willow. The sways 150 are used with spars, iron crooks or screw fixings (not shown) to secure the bundles of thatch 140 to the rafters 110 and/or roof battens 120.

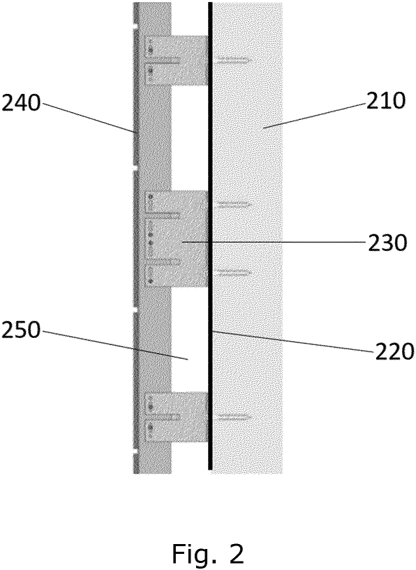

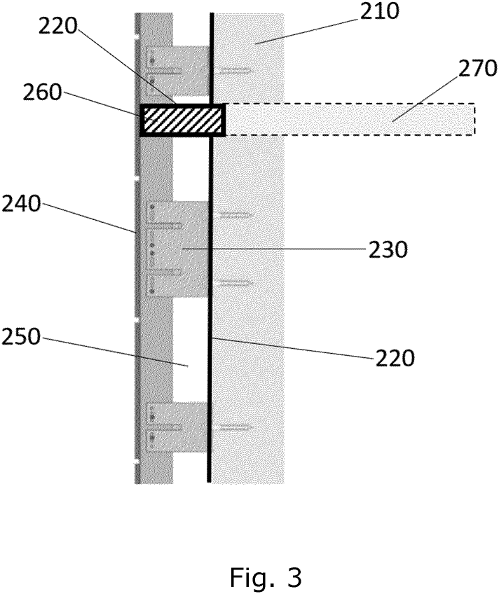

FIG. 2 is a cross-sectional view of a part of a façade in accordance with various embodiments of the invention. Here, the façade is established by lining the outer face of a building wall 210 with a mineral fibrous sheet material 220. The mineral fibrous sheet material 220 has a Temperature Index measured according to ISO 4589-3:2017 of 400° C. or higher, and has a thickness of at most 1 mm. The mineral fibers forming the sheet material 220 is coated with a coating adapted for retarding fire. Then brackets 230 are fastened to the outer face of said building wall 210, and a facade cladding 240 is mounted to said brackets 230. The brackets 230 are mounted such that a cavity 250 is formed between the building wall 210 and façade cladding 240 to allow for ventilation. FIG. 3 is a cross-sectional view of a part of a façade of a multifloored building in accordance with various embodiments of the invention. Here, the cavity is blocked between two neighboring floors by an object 260 covered by the before mentioned mineral fibrous sheet material 220.

1-16. (canceled)

17. A method for establishing a facade for a building, said method comprising:
lining the outer face of a building wall (210) with a mineral fibrous sheet material (220);
fastening brackets (230) to said outer face of said building wall (210); and
mounting a facade cladding (240) to said brackets (230);
wherein said brackets (230) are mounted such that a cavity (250) is formed between said building wall (210) and facade cladding (240);
wherein said mineral fibrous sheet material (220) has a Temperature Index measured according to ISO 4589-3:2017 of 400° C. or higher, wherein said sheet material (220) has a thickness of at most 1 mm, and wherein mineral fibers forming said sheet material (220) is coated with a coating adapted for retarding fire.

18. The method according to claim 17, wherein said first type of mineral fibrous sheet material (220) has a Limiting Oxygen Index measured according to ISO 4589-3:2017 of 90% or higher.

19. The method according to claim 17, wherein said sheet material (220) has a mass per unit area of 100-500 gram per square meter according to ISO 2286-2:2016.

20. The method according to claim 17, wherein said sheet material (220) has a thickness of within the range of 0.1-0.5 mm.

21. The method according to claim 17, wherein said sheet material (220) is coated with a coating comprising a nonorganic fire-resistant filler.

22. The method according to claim 17, wherein said sheet material (220) has a Temperature Index measured according to ISO 4589-3:2017 above 1100° C.

23. The method according to claim 17, wherein the facade is for a multifloored building, and wherein said cavity (250) is blocked between two neighboring floors by an object (260) covered by mineral fibrous sheet material (220) having a Temperature Index measured according to ISO 4589-3:2017 of 400° C. or higher, wherein said sheet material (220) has a thickness of at most 1 mm, and wherein mineral fibers forming said sheet material (220) is coated with a coating adapted for retarding fire.

24. A facade system comprising:
a mineral fibrous sheet material (220) adapted for lining the outer face of a building wall (210);
a plurality of fastening brackets (230) adapted for being mounted to the outer face of said building wall (210);
a facade cladding (240) adapted for being fastened to said fastening brackets (230);
wherein when mounted, said brackets 230 secures that a cavity 250 is formed between said building wall (210) and said façade cladding (240) to allow for ventilation; wherein said mineral fibrous sheet material (220) has a Temperature Index measured according to ISO 4589-3:2017 of 400° C. or higher, wherein said sheet material (220) has a thickness of at most 1 mm, and wherein mineral fibers forming said sheet material (220) is coated with a coating adapted for retarding fire.

25. The facade system according to claim 24, wherein said sheet material (220) has a thickness of within the range of 0.1-0.5 mm.

26. The facade system according to claim 24, wherein said sheet material (220) has a mass per unit area of 100-500 gram per square meter measured according to ISO 2286-2:2016.

27. The facade system according to claim 24, wherein said sheet material (220) is coated with a coating comprising a nonorganic fire-resistant filler.

28. The facade system according to claim 24, wherein said sheet material (220) has a Limiting Oxygen Index measured according to ISO 4589-3:2017 of 90% or higher.

29. The facade system according to claim 24, wherein said sheet material (220) has a Temperature Index measured according to ISO 4589-3:2017 above 1100° C.

30. The facade system according to claim 24, wherein the facade system is for a multifloored building, said façade system further comprising:
an object (260) adapted for blocking said cavity (250) between two neighboring floors, wherein said object (260) is covered by mineral fibrous sheet material (220) having a Temperature Index measured according to ISO 4589-3:2017 of 400° C. or higher, wherein said sheet material (220) has a thickness of at most 1 mm, and wherein mineral fibers forming said sheet material (220) is coated with a coating adapted for retarding fire.
